(19) United States
(12) Patent Application Publication
(10) Pub. No.: US 2026/0319210 A1
(43) Pub. Date: Oct. 15, 2026

(54) SYSTEMS AND METHODS FOR ORIENTED FIBER OPTIC RIBBONS AND ASSEMBLIES

(71) Applicant: CORNING RESEARCH & DEVELOPMENT CORPORATION, Corning, NY (US)

(72) Inventor: Martin Hempstead, Painted Post, NY (US)

(21) Appl. No.: 19/690,282

(22) Filed: May 28, 2026

Related U.S. Application Data
(63) Continuation of application No. PCT/US2024/056684, filed on Nov. 20, 2024.
(60) Provisional application No. 63/604,215, filed on Nov. 30, 2023.

(51) Int. Cl. G02B 6/44

(52) U.S. Cl. CPC G02B 6/448

(57) ABSTRACT

Provided are embodiments of an optical fiber ribbon. The optical fiber ribbon includes at least one rotationally oriented optical fiber aligned along a length of the optical fiber ribbon. The optical fiber includes a cladding region having a first shear modulus and a first radius and a core and at least one stress member disposed within the cladding region, or two or more cores disposed within the cladding region. The optical fiber ribbon further includes a coating layer surrounding the cladding region and having a second shear modulus and a second radius. The at least one rotationally oriented optical fiber has a characteristic length. Embodiments of methods for preparing such an optical fiber ribbon are also provided.

### RELATED APPLICATIONS

This application is a continuation of International Patent Application No. PCT/US2024/056684, filed on Nov. 20, 2024, which claims the benefit of priority of U.S. Provisional Patent Application No. 63/604,215, filed on Nov. 30, 2023, and entitled “SYSTEMS AND METHODS FOR ORIENTED FIBER OPTIC RIBBONS AND ASSEMBLIES,” the entirety of which is incorporated herein by reference.

### BACKGROUND

Optical fibers are provided in multiple different designs to serve specific functions within an optical system. In general, optical fibers include a core or cores to carry optical signals, a cladding to trap the optical signal within the core and a polymer coating or coatings to protect the fibers and reduce the impact of external perturbations. For optical fibers for certain specialized applications, the optical fiber may be designed with a non-rotationally-symmetric structure (for example, polarization-maintaining fiber (PMF) or multicore fiber (MCF)). Furthermore, in some applications a particular rotational orientation of this specialized fiber may be desired. This orientation may have an effect on the way optical signals are coupled into or out of the optical fiber.

### SUMMARY

The present disclosure generally relates to optical fiber ribbons and in particular to optical fiber ribbons in which the optical fibers are maintained in a desired orientation. In some applications, it is desirable to incorporate one or more of such fibers into a multifiber ribbon with the internal fiber structure held in a desired rotational orientation by the ribbon matrix. Thus, it may be important to design optical fibers that integrate with the ribbonized structure to maintain a proper orientation of the optical fiber during connectorization and to select fiber feedstock that will maintain the alignment to an acceptable tolerance during connectorization.

In one aspect, embodiments of the disclosure relate to an optical fiber ribbon. In one or more embodiments, the optical fiber ribbon includes at least one rotationally oriented optical fiber aligned along a length of the optical fiber ribbon. The optical fiber includes a cladding region having a first shear modulus and a first radius and either a core and at least one stress member disposed within the cladding region, or two or more cores disposed within the cladding region. The optical fiber ribbon further includes a coating layer surrounding the cladding region and having a second shear modulus and a second radius. The at least one rotationally oriented optical fiber has a characteristic length, which characteristic length is defined below.

In another aspect, embodiments of the disclosure relate to a method of processing an optical fiber suitable for use in connectorization of a rotationally oriented optical fiber ribbon. In one or more methods of the embodiment, a maximum intrinsic twist rate of the optical fiber is defined. The intrinsic twist rate of the optical fiber at a position in a segment along the length of the optical fiber is determined. The intrinsic twist rate of the optical fiber is compared to the maximum intrinsic twist rate. The optical fiber is accepted for use in ribbonization when the intrinsic twist rate is less than the maximum intrinsic twist rate. In one or more embodiments of the method, the optical fiber is marked at the segment where the intrinsic twist rate is less than the maximum intrinsic twist rate to indicate acceptance of the marked optical fiber segment for incorporation in a connector. In one or more embodiments of the method, the optical fiber is wound around a reel.

In another aspect, embodiments of the disclosure relate to a method of connecting an optical fiber for use in a rotationally oriented optical fiber ribbon to another optical fiber ribbon or connector. In one or more methods of the embodiment, a maximum error in angular alignment of an optical fiber ribbon after incorporation of a point-by-point spin compensation into an oriented ribbon. The spin angle of the optical fiber with respect to a length of the optical fiber and a rate of change of the spin angle of the optical fiber is determined. In one or more methods, the alignment error of the optical fiber is calculated and a comparison of the alignment error of the optical fiber to the maximum error in angular alignment is performed. The optical fiber is accepted when the alignment error is less than the maximum alignment error. The optical fiber ribbon is connected to a connector or another optical fiber ribbon at a segment of the optical fiber where the alignment error is less than the maximum alignment error.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a cross-sectional view of a rotationally oriented optical fiber, according to an exemplary embodiment.

FIGS. 2A-2D are perspective views of the rotationally oriented optical fiber of FIG. 1 when cut and/or stripped according to an exemplary embodiment.

FIG. 3 is a plot of spin angle and spin rate of a polarization-maintaining fiber in an unstressed unoriented state as a function of length, according to an exemplary embodiment.

FIG. 4 is a flow diagram of a method of selecting an optical fiber with a chosen maximum intrinsic twist rate, according to an exemplary embodiment.

FIG. 5 is a flow diagram of a method of selecting an optical fiber with a chosen alignment precision, according to an exemplary embodiment.

### DETAILED DESCRIPTION

Referring generally to the figures, embodiments of an optical fiber ribbon having one or more optical fibers with a rotationally oriented optical structure (e.g., polarization-maintaining (PMF) optical fibers or multi-core (MCF) optical fibers) designed to have limited rotational recoil during connectorization are described. As will be generally understood, in a ribbon with rotationally oriented fibers, the optical fibers are held in a twisted state by circumferential stresses arising from strains in the coating or coatings of the optical fiber and in the ribbon matrix. In an ideally oriented ribbon, cutting the ribbon and cleaving the fibers would not affect the rotational orientation of the fibers. However, because the fiber is generally in a torqued state, the optical fiber will relax or recoil and rotate when constraints imposed by the ribbon matrix are reduced such as by cleaving the optical fiber. Stripping the cleaved fiber will result in further relaxation.

Applicant has found a characteristic length of the optical fiber controls the recoil of the optical fiber, the decay of the extrinsic twist along the length of the optical fiber when one end is twisted and the other end is anchored, and the range of twist spatial periods over which point-by-point twist correction is effective. The extrinsic twist is defined as twist of the optical fiber along its length that is induced by external forces, such as torques applied to the fiber at its ends and/or on its circumference. For example, extrinsic twist can be introduced during the winding process where the optical fiber passes over a pulley, and it can be maintained in a reel of optical fiber by friction. Spooling or otherwise winding the optical fiber from one reel or pulley to another or from a pulley to a ribbon-forming process will likely change the amount and distribution of extrinsic twist. The various optical fiber embodiments discussed herein include a characteristic length to limit the rotational recoil caused by cleaving and stripping the optical fiber that facilitates making connections between the polarization axes of PMF optical fibers or the core constellation of MCF optical fibers that require specific orientation for successful connections.

Furthermore, as will be discussed herein, Applicant has developed methods of processing and selecting optical fiber feedstock suitable for connectorization of ribbons containing rotationally oriented fibers based on the intrinsic twist rate of the optical fibers and the rotational alignment of the optical fiber. The intrinsic twist rate is defined as the rotation of the internal fiber structure present when the optical fiber is in an untorqued, stress-free, relaxed state. Such intrinsic twist is a property of the optical fiber regardless of the winding history of the optical fiber. For example, rotation of the stress members or rods of a PMF formed when the optical fiber was produced may contribute to intrinsic twist.

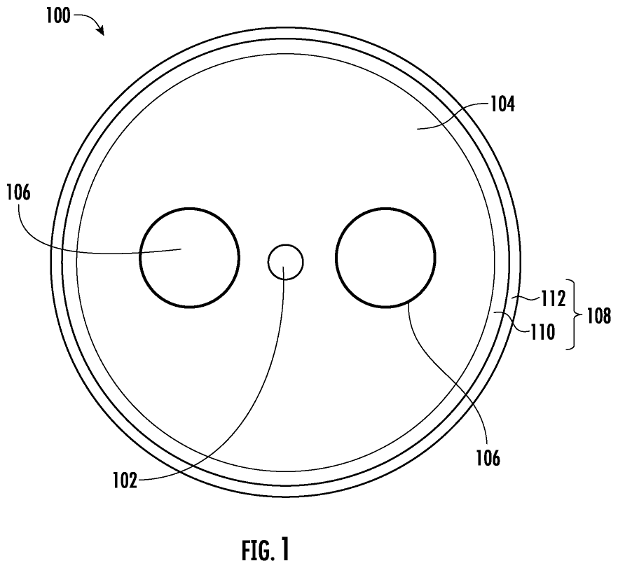

Referring to FIG. 1, a cross-section of a rotationally oriented optical fiber 100 such as a polarization-maintaining (PM) optical fiber is shown according to an exemplary embodiment. As will be discussed in greater detail below, the rotationally oriented optical fiber 100 could also be a multi-core (MC) optical fiber. The optical fiber 100 has a circular cross-section that extends along a longitudinal axis of a length of the optical fiber 100.

In various embodiments, when the optical fiber 100 is a PM optical fiber a core 102 is surrounded by a cladding 104. In various embodiments, the core 102 has a circular cross-section that extends along and is situated on the longitudinal axis of the optical fiber 100. The core 102 of the PM optical fiber 100 may be a single mode core that is single mode above a specified wavelength.

In various embodiments, when optical fiber 100 is a MC optical fiber, more than one core 102 is surrounded by cladding 104. In various embodiments, each of the more than one cores 102 have a circular cross-section that extends along and is situated on or parallel to the longitudinal axis of the optical fiber 100. In a specific embodiment, the MC optical fiber 100 includes two or more cores 102 disposed within the cladding 104. In various embodiments, the MC optical fibers include from 2 cores 102 to 4 cores 102. In various embodiments, the MC optical fibers include from 2 cores 102 to 8 cores 102.

The cladding 104 surrounds the core 102 along the length of the optical fiber 100. For the PM optical fiber 100, disposed within the cladding 104 are one or more stress members 106. As shown in FIG. 1, in various specific embodiments, the PM optical fiber 100 includes two circular stress members 106 diametrically arranged around the core 102 and that extend along the length of the optical fiber 100.

In one or more embodiments, the cladding 104 is surrounded by at least one coating layer 108, such as a primary coating layer 110 and a secondary coating layer 112. The at least one coating layer 108 provides mechanical protection for the optical fiber 100. In embodiments, the primary coating layer 110 is a soft, curable resin that provides cushioning for the core 102 and cladding 104, and the secondary coating layer 112 is a hard, curable resin that provides protection against external stresses.

In various embodiments, the primary coating layer 110 and the secondary coating layer 112 are thin. In some embodiments, a thickness of the primary coating layer 110 and a thickness of the secondary coating layer 112 are the same. In various embodiments, the primary coating 110 has a first stiffness and the secondary coating has a second stiffness, with the first stiffness being less than the second stiffness.

With reference to the various PM optical fiber embodiments, the refractive index at various positions of the PM optical fiber 100 will vary across the diameter. The refractive index in the primary coating 110, the cladding 104, and the core 102 is different from the refractive index in the other regions. For example, in various embodiments, the core 102 has a first refractive index and the cladding has a second refractive index. In such an embodiment, the second refractive index is different than the first refractive index.

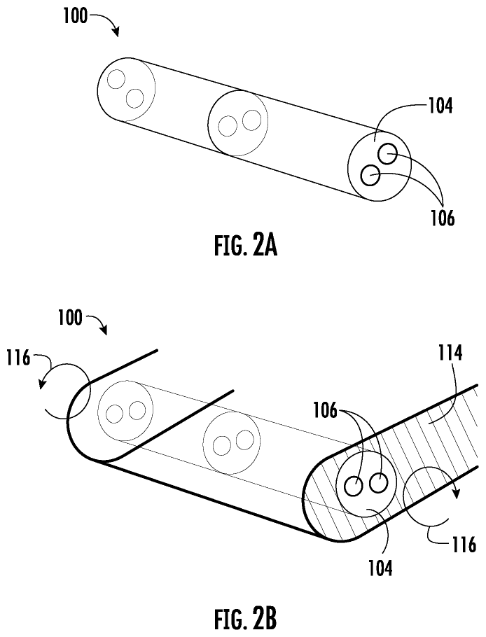

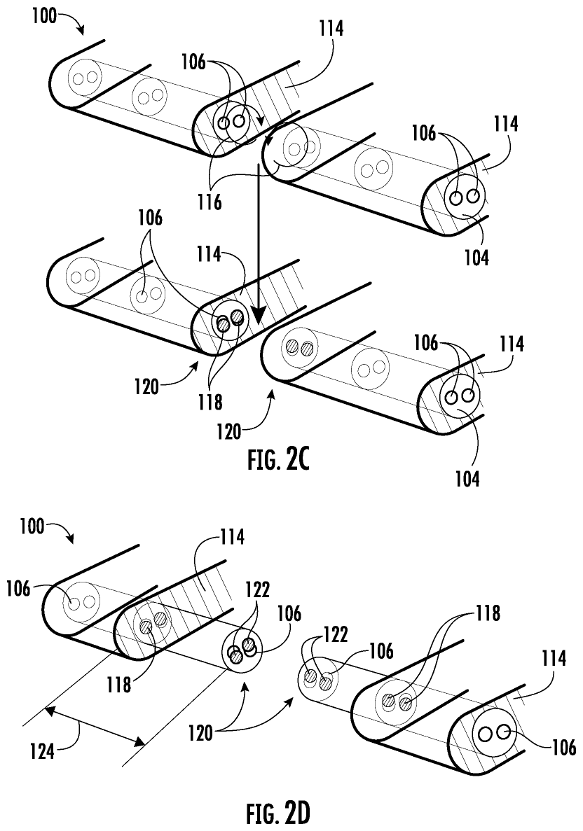

Referring to FIGS. 2A-2D, perspective views of the rotationally oriented optical fiber 100, when cut and/or stripped are shown according to an exemplary embodiment. As illustrated schematically in FIGS. 2A-2D, optical fibers 100 are shown without coating layer 108 and core(s) 102.

As shown in FIG. 2A, optical fiber 100 is in a relaxed state. As will be generally understood, when optical fiber 100 is in an untorqued, stress-free, relaxed state optical fiber 100 typically has an intrinsic twist or spin regardless of the winding history of the optical fiber 100. In contrast, there will generally be extrinsic twist along the length of optical fiber 100 that is induced by external forces such as torque. Extrinsic twist is frequently introduced to optical fibers 100 during production, for example during winding, where the fiber passes over a pulley, and such extrinsic twist can be maintained in the reel of optical fibers by friction. As previously noted, optical fiber 100 will relax or recoil causing rotation when the optical fiber 100 is cleaved or cut because the constraints on the optical fiber 100 are reduced.

As noted above, the intrinsic twist is the rotation of the internal fiber structure that may be produced as a result of twisting of the optical fiber at the blank root during drawing, such as stress member 106 formed during production of optical fiber 100. In such an embodiment, the internal structure including the stress member 106 has a spin rate −t defined in turns/m, degrees/m, radians/m etc.

Referring to FIG. 2B, optical fiber 100 is embedded in a ribbon matrix 114. An extrinsic twist rate is applied by the extended portions of the ribbon (not shown in the figure) to optical fiber 100 by a torque shown by arrow 116. As will be generally understood, when optical fiber 100 has an ideal orientation, at any point along the length of the optical fiber 100, the extrinsic twist rate t compensates for the intrinsic twist rate −t at that point.

Referring to FIG. 2C, the cleaving of the ribbon and optical fiber 100 is shown, according to an exemplary embodiment. The stress members 106 are shown in a first position. At the instant optical fiber 100 is cleaved or cut, the interfacial torque 116 is removed. Once the torque 116 is removed from cleaved ends 120 of optical fiber 100, the ends rotate into a second position 118 as shown by the changed position of the end sections of stress members 106. The rotation of stress members 106 is due to the development of a reactive torque that builds within coating layer 108 or the primary coating layer 110. As illustrated in FIG. 2C, the torque after cleaving is an end effect only experienced by optical fiber 100 at the cleaved ends 120.

Referring to FIG. 2D, the ribbon matrix 114 and coating 108 of optical fiber 100 are stripped back from the cleaved ends 120. When the ribbon matrix 114 and coating 108 are stripped, there is additional relaxation or recoiling of optical fiber 100. A strip length lₛ 124 is defined between the cleaved end 120 and an end of the ribbon matrix 114.

As shown in FIG. 2D, stress members 106 are in the second position 118 at the end of ribbon matrix 114. The additional relaxation and twisting can be seen in the stress members 106 that have rotated into a third position 122. In order to address the problem of relaxation and twisting of rotationally oriented optical fibers, Applicant has designed various optical fibers with limited rotational recoil after cleaving the optical fiber 100 and stripping back the coating 108 and ribbon matrix 114.

As previously noted, the characteristic length of the optical fiber controls the recoil of the optical fiber, the decay of the extrinsic twist along the length of the optical fiber when one end is twisted and the other end is anchored, and the range over which point-by-point twist correction is effective. For fibers with a secondary coating much stiffer than the primary coating (for example, with a secondary shear modulus at least 100 times the primary shear modulus) the characteristic length l_{c}, depends on parameters of the optical fiber 100 and the coating 108 and can be determined according to the following equation 1:

$${l}_{c} = ( \frac{{r}_{g}}{{r}_{p}} ) \sqrt{( \frac{{G}_{g}}{{G}_{p}} ) ( {r}_{p}^{2} - {r}_{g}^{2} ) / 8} \qquad ( 1 )$$

where r_{g} is the radius of a glass portion of the optical fiber 100 (i.e., the outer radius of the cladding 104 surrounding the core 102), rₚ is the outer radius of the primary coating 110, G_{g} is the shear modulus of the glass portion of the optical fiber 100, and Gₚ is the shear modulus of the primary coating 110. Using this equation, the characteristic length l_{c} of optical fiber 100 which is a function of the optical fiber 100 and coating 108 properties can be calculated. In an example embodiment, the shear modulus G_{g} of the optical fiber 100 is 31.5 GPa and the radius of the glass portion of the fiber r_{g} is 62.5 μm. In such an example, the shear modulus Gₚ of the primary coating 110 may be 0.15 MPa and an outer radius rₚ of the primary coating 110 may be 95 μm. In such an embodiment, the characteristic length l_{c} is about 7 mm.

Applicant has found the characteristic length l_{c} can be reduced by increasing the shear modulus Gₚ of primary coating 110 relative to the shear modulus G_{g} of the optical fiber 100. Similarly, Applicant has found the characteristic length l_{c} can reduced by reducing the ratio of the radius of the fiber r_{g} to the outer radius rₚ of the primary coating 110. Besides computing the characteristic length using equation 1, the l_{c} can be measured mechanically by rigidly fixing or anchoring an end of a section of fiber 100 with twist or rotation applied to the opposing end, and measuring the decay of the twist along the fiber 100. For example, the rotation could be detected by applying a marker or flag to the optical fiber 100 and observing the rotation.

Applicant believes that maintaining a characteristic length in a chosen range for one or more optical fibers with rotationally asymmetric structures as discussed herein, facilitates successful connections between the polarization axes of the PM optical fibers or the core constellation of MC fibers that require specific orientation for connections. In various embodiments, optical fiber 100 has a characteristic length l_{c} less than a maximum characteristic length. The maximum or allowable characteristic length depends on the maximum twist allowed for the fiber feedstock.

As previously noted, when the optical fiber has an ideal orientation, at any point along the length of the optical fiber 100, the extrinsic twist rate t compensates for the intrinsic twist rate −t at that point. A recoil θᵣ when the optical fiber 100 is cleaved at that point and stripped the distance lₛ (assuming there will be a negligible change in the twist rate in that length which is typically 1 cm or less) is given by equation 2:

θᵣ=t(l_{c}+lₛ) (2)

Applicant has found the intrinsic twist rate, −t, the characteristic length, l_{c} and the stripped length lₛ should be controlled to ensure that the recoil is small enough to allow for an oriented connection to be made with an acceptable accuracy.

For example, if the required alignment precision for a PM optical fiber 100 is =5 degrees, the recoil may be required to be less than ±1 degree to allow for other process imperfections that may add error to the alignment. If l_{c}=7.6 mm and lₛ=5.0 mm, then the spin rate −t of the of the optical fiber feedstock for the fiber ribbonization process must be within ±79 degrees/meter. As another example, if lₛ=5.0 mm and the spin rate −t of the optical fiber feedstock is in the range of ±100 degrees/meter, then l_{c} must be less than 5 mm.

If the application requires the recoil effect to be within ±0.5 degrees, and with an l_{c}=7.6 mm and lₛ=5.0 mm, then the spin rate −t of the fiber feedstock must be kept within ±40 degrees/meter. As another example, for fiber feedstock with spin rate −t in the range ±100 degrees/meter, the total of l_{c} and lₛ must be less than 5 mm. Similarly, for allowable angular deviations at a chosen probability level, for example a 30 orientation error contribution from recoil of less than 0.5 degrees, the limits on the fiber spin rate −t are similarly specified (e.g., 3σ spin rate bounds of ±40 degrees/meter when the total of l_{c} and lₛ=12.6 mm).

Additionally, Applicant has found that twist applied on the outside surface of the fiber coating 108 does not necessarily result in a corresponding twist of the internal structures or center of the optical fiber 100. There is a Fourier transform relationship between the twist rate function and the resulting twist on the optical fiber. For an intrinsic twist with an orientational angle as a function of position z along the optical fiber θ_{g}(z) and a corresponding Fourier Transform (FT) \tilde{θ}_{g}(ω), the extrinsic twist at the outer surface of secondary coating 112 required to compensate for the intrinsic twist is given by equation 3:

\tilde{θ}_{g}(ω)(1+l_{c}²ω2) (3)

ω<<1/l_{c} (4)

where ω the spatial angular frequency (in radians). Applicant has found that when ω<<1/l_{c}, the Fourier Transform of the required twist is nearly the same as that of the target twist. In other words, the required extrinsic twist for compensation is equal and opposite to the intrinsic twist at every point with negligible non-local contributions.

The error in angular alignment, introduced by rotating the external secondary coating 112 surface of the optical fiber on a point-by-point basis by an angle equal to the opposite of its deviation from the desired fiber orientation, is given by equation 5:

$${θ}_{err} ( z ) = - {l}_{c}^{2} \frac{{\partial }^{2} {θ}_{g}}{\partial {z}^{2}} \qquad ( 5 )$$

To keep the contribution from the error in angular alignment below ±1 degree, the second derivative of the spin angle with respect to length along the feedstock fiber must be kept within the range of ±1°/l_{c}′. For example, when l_{c}=7.6 mm this is about =1.7/cm².

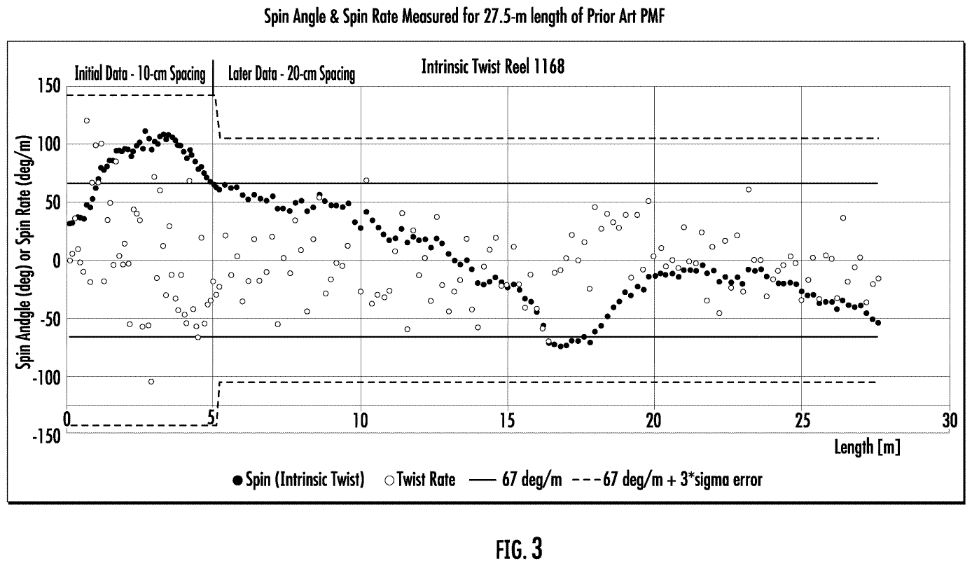

Referring to FIG. 3, a plot of spin angle and spin rate of a stress-free prior art optical fiber as a function of length is shown, according to an exemplary embodiment. Multiple contiguous sections of the prior art optical fiber from one feedstock reel were measured. As shown in the plot, the peak spin rate is about 50-100 degrees/meter which is generally consistent with a recoil contribution of 1-2 degrees to the alignment error in connectorization. The second derivative of the spin angle with respect to length (see equation 5) has a magnitude up to about 0.2 degrees/cm² which is consistent with a contribution to the alignment error of approximately 0.1 to 0.2 degrees.

Applicant has found the maximum intrinsic twist rate can be controlled by calibration and alignment of the fiber draw, measuring the intrinsic twist rate to confirm it is low enough, or both careful calibration and alignment of the fiber draw and measuring the intrinsic twist rate to confirm it is low enough. Specifically, the calibration and alignment includes controlling the angle at which the fiber runs or moves over pulleys and sheaves during a fiber draw process. Applicant believes controlling the angle of the fiber to be close to a right angle to the axis of rotation of the pulleys and sheaves during such process, accurately aligning the pulley or sheave surfaces to the axis of rotation, and keeping precision of the axis of rotation below a maximum angle can aid in control of intrinsic twist of a fiber.

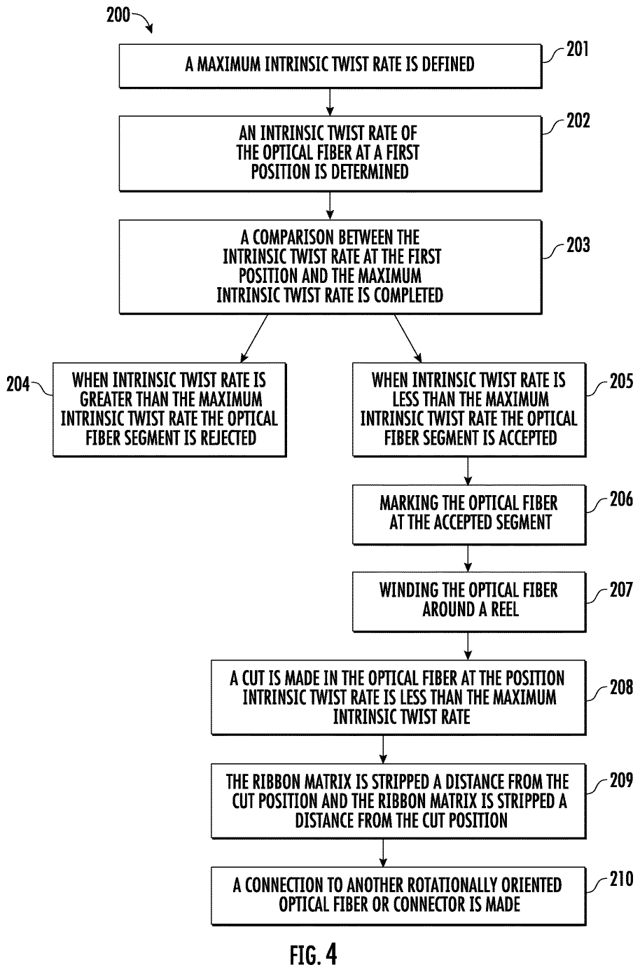

In view of the foregoing discussion of the orientation and alignment of rotationally oriented optical fiber 100, embodiments of a method of processing an optical fiber suitable for use in connectorization of a rotationally oriented optical fiber ribbon with a chosen intrinsic twist rate for use in a rotationally oriented optical fiber ribbon is described in FIG. 4. In various embodiments, a method 200 of processing optical fiber 100 includes defining a maximum intrinsic twist rate for the ribbonization process in a first step 201. In various embodiments, the maximum intrinsic twist rate is within ±100 degrees/m, within ±79 degrees/m, within ±40 degrees/m. In other embodiments, the acceptable maximum intrinsic twist rate may be different due to the application.

The intrinsic twist rate of the optical fiber 100 at a first position along the optical fiber is determined in a second step 202. In a specific embodiment, the intrinsic twist rate of the optical fiber is measured. The intrinsic twist rate from the second step 202 is compared to the maximum intrinsic twist rate defined in the first step 201 in a third step 203. If the intrinsic twist rate from second step 202 is greater than the maximum intrinsic twist rate defined in the first step 201, the optical fiber is rejected as unsuitable for alignment during connection in a fourth step 204. If the intrinsic twist rate from second step 202 is less than the maximum intrinsic twist rate defined in the first step 201, the optical fiber is determined to be acceptable for alignment for connection in a fifth step 205. In some embodiments, the optical fiber ribbon and/or optical fiber is marked or labeled at the acceptable portion of the optical fiber for easy identification of the portion of the optical fiber selected for use in connecting oriented optical fiber ribbons in a sixth step 206. In some embodiments, the optical fiber ribbon and/or optical fiber is marked or labeled at the unacceptable portion of the optical fiber for easy identification of the portion of the optical fiber unsuitable for use in connecting oriented optical fiber ribbons. In various embodiments, the unacceptable portions of the optical fiber can be excised from the optical fiber.

In various embodiments, determining the intrinsic twist rate of the optical fiber can be repeated at a second position along the optical fiber. In a specific embodiment, the determination of the intrinsic twist rate of the optical fiber is repeated after a chosen distance (e.g., every 10 cm, every 25 cm etc.) along the length of the optical fiber. For each determined intrinsic twist rate, a comparison to the defined maximum twist rate is completed and an acceptance or rejection of the segment of the optical fiber containing the measurement point is made. In other embodiments, a single determination of intrinsic twist rate along the optical fiber is made and the entire reel of feedstock is accepted or rejected. In various embodiments, the intrinsic twist rate is measured continuously along the length of the optical fiber.

In various embodiments, the optical fiber is run over pulleys and sheaves. In such embodiments, the optical fiber is wound around a storage device such as a reel in a seventh step 207.

During connectorization, the selected optical fiber 100 is cleaved or cut at the position where the intrinsic twist rate is less than the maximum intrinsic twist rate in an eighth step 208. In various embodiments, the ribbon matrix is stripped the distance or stripping length 124 from the cleaved end 120 of the optical fiber 100 in a ninth step 209. A connection is made between the optical fiber 100 and specifically the cleaved end 120 and a connector or another rotationally oriented optical fiber in a tenth step 210.

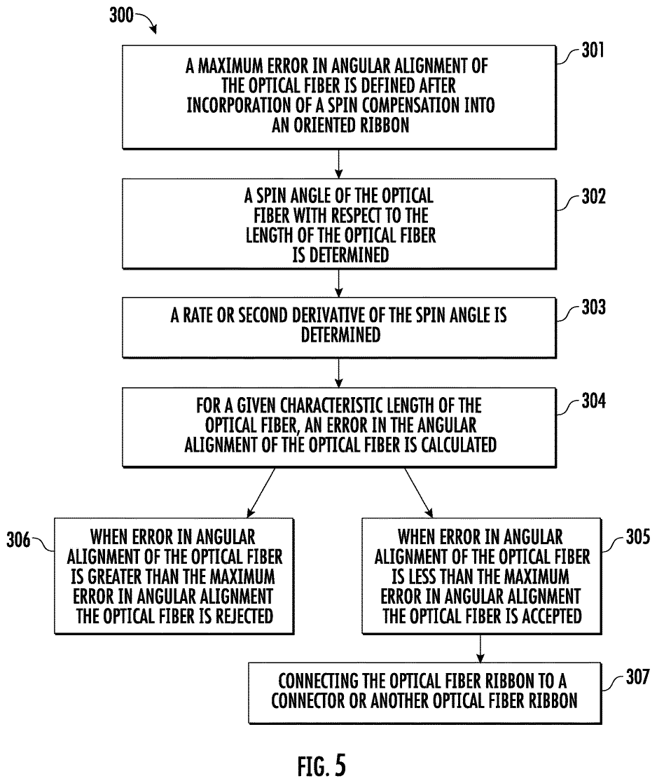

Various embodiments of a method of connecting an optical fiber with a suitable intrinsic twist rate is described in FIG. 5. In various embodiments, a method 300 of connecting an optical fiber 100 includes defining a maximum error in angular alignment for the ribbonization process in a first step 301. In various specific embodiments, the maximum error in angular alignment is ±1 degree.

An orientational angle or spin angle of the optical fiber 100 with respect to the length of the optical fiber 100 is determined in a second step 302. The second derivative of the spin angle with respect to the length of the optical fiber 100 is determined in a third step 303. For a given characteristic length of the optical fiber, an alignment error of the optical fiber 100 with respect to the length of the optical fiber 100 is calculated in a fourth step 304. In various embodiments, the characteristic length squared multiplied by the second derivative of the spin angle is used to calculate the alignment error.

If the alignment error from fourth step 304 is less than the maximum error in angular alignment defined in the first step 301, the optical fiber is determined to be acceptable for alignment during connectorization or splicing in a fifth step 305. In some embodiments, the acceptable portion of the optical fiber is marked or labeled for easy identification of the portion of the optical fiber selected for use in oriented ribbons. If the alignment error from fourth step 304 is greater than the maximum error in angular alignment defined in the first step 301, the optical fiber is determined to be unacceptable for alignment during connection in a sixth step 306.

In various embodiments, the optical fiber ribbon and/or optical fiber is marked or labeled at the acceptable portion of the optical fiber for easy identification of the portion of the optical fiber selected for use in connecting oriented optical fiber. In various embodiments, the optical fiber ribbon and/or optical fiber is marked or labeled at the unacceptable portion of the optical fiber for easy identification of the portion of the optical fiber unsuitable for use in connecting oriented optical fiber ribbons. In various embodiments, the optical fiber is run over pulleys and sheaves. In such embodiments, the optical fiber is wound around a storage device such as a reel.

The selected optical fiber is connected to another optical fiber ribbon or connector in a seventh step 307. In various embodiments, this connection process includes cleaving the optical fiber 100 at the chosen segment or point and stripping a ribbon matrix from the cleaved end 120, before connecting to another optical fiber ribbon or connector. In various specific embodiments, the optical fiber 100 is cleaved at an acceptable segment and the ribbon matrix is stripped from the cleaved end 120, before incorporating the optical fiber into a connector.

The optical transmission elements discussed herein include optical fibers that may be flexible, transparent optical fibers made of glass or plastic. The fibers may function as a waveguide to transmit light between the two ends of the optical fiber. Optical fibers may include a transparent core surrounded by a transparent cladding material with a lower index of refraction. Light may be kept in the core by total internal reflection. Glass optical fibers may comprise silica, but some other materials such as fluorozirconate, fluoroaluminate and chalcogenide glasses, as well as crystalline materials such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage. These coatings may be UV-cured urethane acrylate composite materials applied to the outside of the optical fiber during the drawing process. The coatings may protect the strands of glass fiber.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber ribbon comprising:
at least one rotationally oriented optical fiber aligned along a length of the optical fiber ribbon, the at least one rotationally oriented optical fiber comprising:
a cladding region having a first shear modulus G_{g}, and a first radius r_{g};
(i) a core and at least one stress member disposed within the cladding region; or
(ii) two or more cores disposed within the cladding region; and
a coating layer surrounding the cladding region, the coating layer having a second shear modulus Gₚ and a second radius rₚ;
the at least one rotationally oriented optical fiber having a characteristic length l_{c} defined as
$$( {r}_{g} / {r}_{p} ) * \sqrt{( \frac{{G}_{g}}{{G}_{p}} ) ( {r}_{p}^{2} - {r}_{g}^{2} ) / 8}$$
and an extrinsic twist rate t defined at an outer surface of the coating layer;
wherein the at least one rotationally oriented optical fiber is configured to be cleaved and stripped a distance lₛ,
wherein a recoil of the at least one rotationally oriented optical fiber when cleaved is defined as t(l_{c}+lₛ) and wherein the recoil is within ±5 degrees.

2. The optical fiber ribbon of claim 1, wherein the recoil is within ±1 degree.

3. The optical fiber ribbon of claim 1, wherein the characteristic length is less than a maximum characteristic length.

4. The optical fiber ribbon of claim 1, wherein the at least one rotationally oriented optical fiber is a plurality of rotationally oriented optical fibers arranged adjacently.

5. The optical fiber ribbon of claim 4, wherein each of the at least one stress member of the optical fiber has a same orientation as the at least one stress member of each other of the plurality of optical fibers.

6. The optical fiber ribbon of claim 4, wherein the at least one stress member is configured to maintain polarization of light in each of the cores.

7. The optical fiber ribbon of claim 1, wherein the at least one stress member comprises two stress members diametrically opposed on opposite sides of the core.

8. The optical fiber ribbon of claim 7, wherein the two stress members comprise circular cross-sections.

9. The optical fiber ribbon of claim 1, wherein the two or more cores comprises from 2 cores to 4 cores disposed within the cladding region.

10. The optical fiber ribbon of claim 1, wherein the coating layer comprises a primary coating layer and a secondary coating layer, and wherein the primary coating layer is adjacent to the cladding region.

11. The optical fiber ribbon of claim 10, the primary coating layer has a first stiffness and the secondary coating layer has a second stiffness, and wherein the first stiffness is less than the second stiffness.

12. The optical fiber ribbon of claim 1, further comprising a ribbon matrix surrounding the at least one rotationally oriented optical fiber.

13. The optical fiber ribbon of claim 12, wherein, when the at least one rotationally oriented optical fiber is cut at a point along the length of the optical fiber and the ribbon matrix is removed the stripping distance lₛ that is defined between the cut point and an end of the ribbon matrix.

14. A method of processing an optical fiber suitable for use in connectorization of a rotationally oriented optical fiber ribbon comprising:
defining a maximum intrinsic twist rate of the optical fiber;
determining the intrinsic twist rate of the optical fiber at a position in a segment along a length of the optical fiber;
comparing the intrinsic twist rate of the optical fiber to the maximum intrinsic twist rate;
accepting the optical fiber for use in ribbonization when the intrinsic twist rate is less than the maximum intrinsic twist rate;
marking the optical fiber at the segment where the intrinsic twist rate is less than the maximum intrinsic twist rate to indicate acceptance of the marked optical fiber segment for incorporation in a connector; and
winding the optical fiber around a reel.

15. The method of claim 14, further comprising:
cutting the optical fiber at the position wherein the intrinsic twist rate is less than the maximum intrinsic twist rate;
stripping a ribbon matrix a distance from the position of the cut; and
connecting the optical fiber to a connector.

16. The method of claim 14, further comprising marking the optical fiber at a segment where the intrinsic twist rate is greater than the maximum intrinsic twist rate to indicate rejection of the marked optical fiber segment for incorporation in the connector.

17. The method of claim 16, further comprising rejecting the reel of the optical fiber for use in connectorization when the optical fiber contains the segment marked as having the intrinsic twist rate that is greater than the maximum intrinsic twist rate.

18. The method of claim 14, further comprising determining a second intrinsic twist rate of the optical fiber at a second segment along the length of the optical fiber and comparing the second intrinsic twist rate of the optical fiber to the maximum intrinsic twist rate.

19. A method of connecting an optical fiber for use in a rotationally oriented optical fiber ribbon to another optical fiber ribbon or connector comprising:
defining a maximum error in angular alignment of an optical fiber after incorporation of a point-by-point spin compensation into an oriented ribbon;
determining a spin angle of the optical fiber with respect to a length of the optical fiber and a rate of change of the spin angle of the optical fiber;
calculating the alignment error of the optical fiber; and
comparing the alignment error of the optical fiber to the maximum error in angular alignment;
accepting the optical fiber when the alignment error is less than the maximum alignment error; and
connecting the optical fiber ribbon to a connector or another optical fiber ribbon at a segment where the alignment error is less than the maximum alignment error.

20. The method of claim 19, further comprising marking the optical fiber at the segment where the alignment error is less than the maximum alignment error to indicate acceptance of the marked optical fiber segment for connection to the connector or another optical fiber ribbon before connecting the optical fiber ribbon to a connector or another optical fiber ribbon.
